(19) United States
(12) Patent Application Publication
(10) Pub. No.: US 2011/0155691 A1
(43) Pub. Date: Jun. 30, 2011

(54) MANUFACTURING METHOD OF MAGNETIC RECORDING MEDIUM

(75) Inventor: Ge Xu, Hachioji-shi (JP)

(73) Assignee: CANON ANELVA CORPORATION, Kawasaki-shi (JP)

(21) Appl. No.: 12/974,881

(22) Filed: Dec. 21, 2010

(30) Foreign Application Priority Data
Dec. 28, 2009 (JP) 2009-296616

(51) Int. Cl. G11B 5/84

(52) U.S. Cl. 216/22

(57) ABSTRACT

The present invention provides a manufacturing method of a magnetic recording medium capable of reducing the deterioration of a recording layer and improving the Duty cycle of the recording layer. An embodiment of the present invention is a manufacturing method of a patterned recording medium such as BPM (Bit Patterned Media) and DTM (Discrete Track Media). The manufacturing method has a deposition step of depositing a resist protective film on a resist pattern formed on a workpiece containing a recording layer, and a recording layer processing step of processing the recording layer into a pattern shape by dry etching using the resist pattern and the resist protective film as a mask.

### BACKGROUND OF THE INVENTION

1. Field of the Invention

The present invention relates to a manufacturing method of a magnetic recording medium suitable for pattern-processing a recording layer.

2. Description of the Related Art

According to a prior art, in the manufacturing process of patterned recording media such as BPM (Bit Patterned Media) and DTM (Discrete Track Media), a resist layer is patterned into a prescribed pattern shape, and, based on the resist, the recording layer is processed into the pattern shape by dry etching.

In recent years, as a formation method of a pattern of convex and concave parts in the resist layer to be an etching mask, an imprint method, in which a mold is compressed to the resist layer to form a pattern, has been used frequently because it gives an excellent productivity. But, according to the method, the Duty cycle (the ratio occupied by the convex part in the pattern of convex and concave parts) of the resist after the pattern formation by the mold is less than 60%, and, moreover, after passing through the process of resist processing for removing the resist left at the bottom part, the sidewall of the convex part is simultaneously etched to further lower the Duty cycle. Moreover, the resist is also etched and shrunk in the process of recording layer processing using the resist as an etching mask, and, therefore, the Duty cycle of the recording layer pattern obtained further lowers than that of the resist pattern. Since resists generally used are heat-curable, they are easily shrunk by the heat ejected from plasma etc. at the time of the processing to generate easily the lowering of the Duty cycle and processing variation.

In contrast to this, in order to improve the Duty cycle of the processed pattern of a recording layer, there is a method of forming a multilayer hard mask under the resist layer (see Japanese Patent Application Laid-open Publication No. 2005-50468). The method makes use of a carbon film to be an etching mask for the recording layer and a silicide or metal film having a large etching selectivity relative to the carbon film for processing the carbon film, as a multilayer hard mask over the recording layer.

The method shown in Japanese Patent Application Laid-open Publication No. 2005-50468 makes use, however, of reactive etching using a fluorinated gas as a reactive gas for processing the silicide and the metal films. Through the etching process by the fluorinated gas, fluorine remains on the substrate or substrate holder, which causes the corrosion of a magnetic film being the recording layer to be induced.

### SUMMARY OF THE INVENTION

The present invention aims at providing a manufacturing method of a magnetic recording medium capable of reducing the deterioration of the recording layer and improving the Duty cycle of the recording layer.

One aspect of the present invention is a manufacturing method of magnetic recording medium that processes a recording layer by etching, comprising the steps of: depositing a material having an etching rate by the etching lower than that of the recording layer, on a resist pattern formed on a workpiece containing the recording layer, and processing the recording layer into the same shape as the resist pattern by the etching using the resist pattern and the material as a mask.

The magnetic recording medium patterned by the above method has an improved Duty cycle of the recording layer pattern, as compared with a medium patterned by a processing process using a resist mask alone. That is, the land width of the recording layer contributing to magnetic recording becomes wider, which leads to the improvement of the recording density of the magnetic recording medium.

### BRIEF DESCRIPTION OF THE DRAWINGS

FIGS. 1A to 1F are drawings showing the flow of substrate treatment process from resist processing to mask removal being an embodiment of the present invention.

FIG. 2 is a drawing showing a constitution example of manufacturing equipment for executing the flow in FIG. 1.

FIG. 3 is a drawing showing a SEM (scanning electron microscope) photograph of a workpiece before the process of resist processing according to an embodiment of the present invention.

FIG. 4 is a drawing showing a SEM photograph of a workpiece after the process of resist processing according to an embodiment of the present invention.

FIG. 5 is a drawing showing a SEM photograph of a workpiece after the deposition of a protective film according to an embodiment of the present invention.

### DETAILED DESCRIPTION OF THE INVENTION

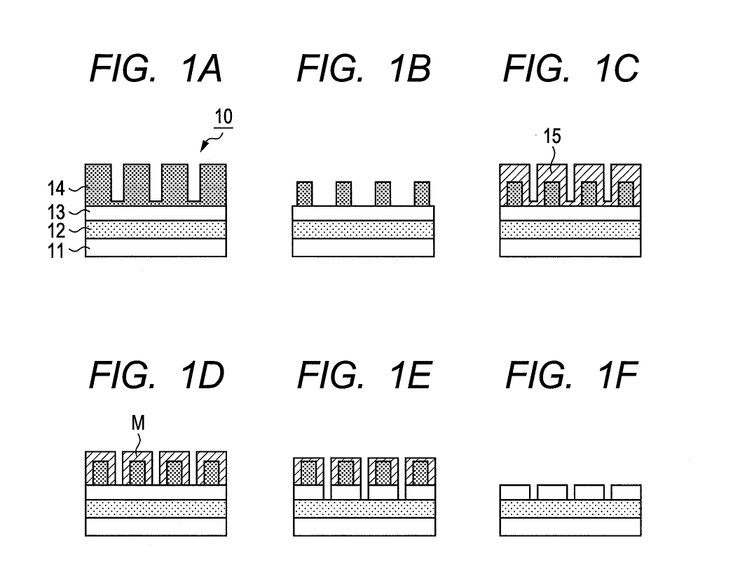

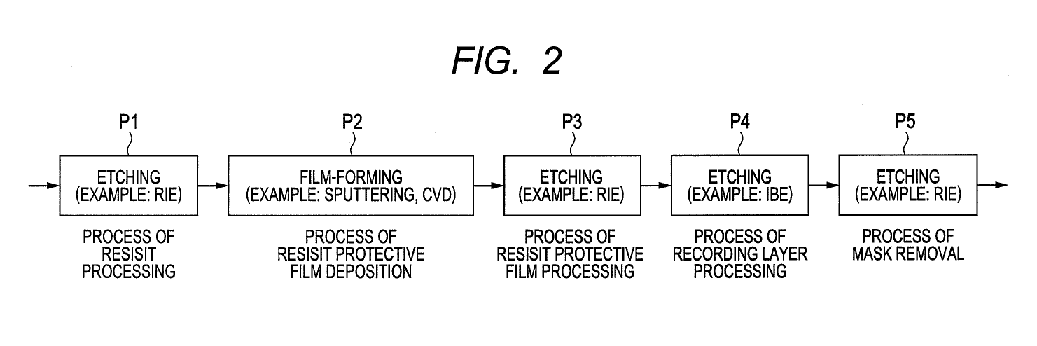

FIGS. 1A to 1F show the flow of substrate treatment processes from the resist processing to the mask removal being an embodiment of the present invention, and FIG. 2 shows an example of the manufacturing apparatus of a magnetic recording medium capable of executing the flow.

The example in FIG. 2 has such a construction that a process chamber P1 for executing the process of resist processing, a process chamber P2 for executing the process of resist protective film deposition, a process chamber P3 for executing the process of resist protective film processing, a process chamber P4 for executing the process of recording layer processing, and a process chamber P5 for executing the process of mask removal are connected hermetically via a gate valve. As described above, substrate treatments from the resist processing to the mask removal are desirably performed in inline apparatus of a vacuum one loop, but treatments may be performed in each independent vacuum chamber along such a flow. Moreover, another process chamber may be connected midway, or before or after these.

In the process of resist processing, the resist processing treatment is performed for a workpiece 10 by, for example, etching in the process chamber P1. Accordingly, the process chamber P1 is constituted so as to be capable of performing, for example, reactive ion etching (RIE). The workpiece 10 shown in FIG. 1A is formed by laminating sequentially a lower layer 12, a recording layer 13 and a resist 14 on a substrate 11, wherein a pattern of convex and concave parts (resist pattern) is previously formed in the resist 14 by an imprint method. That is, the substrate 11 having the resist 14 formed on the recording layer 13 is prepared, the resist 14 having an intended resist pattern formed. In the example in FIG. 1A, there is formed a pattern of concave and convex parts for forming the recording layer 13 of a discrete type having groove-shaped concave parts in parallel with each other.

For the substrate 11, the lower layer 12 and the recording layer 13, known materials can be used, and, as the substrate 11, for example, a glass substrate or an aluminum substrate having a diameter of 2.5 inches (65 mm) can be used. The lower layer 12 is constituted by laminating, for example, a soft magnetic layer containing a soft magnetic material such as an Fe alloy and a Co alloy, and an underlayer containing Ru, Ta etc. for vertically orienting the axis of easy magnetization of the recording layer 13, etc. The recording layer 13 is a layer that is magnetized vertically relative to the substrate 11, and contains a Co alloy etc.

Specifically, in the process of resist processing, the resist 14 remaining at the pattern bottom part of the resist pattern formed in the resist 14 by etching is removed by the process chamber P1 (FIG. 1B). The removing method of the resist can be adopted corresponding to the kind of the resist 14, and is not particularly limited in the present invention. For example, a reactive ion etching using an oxygen gas plasma can be used. Meanwhile, this process is not indispensable to the present invention, and a resist pattern exposing the recording layer 13 at the concave part may be formed by dry etching etc. other than the imprint method. That is, the workpiece 10, in which the recording layer 13 is exposed at the bottom of the resist pattern formed in the resist 14, has only to be prepared before performing the process of resist protective film deposition and subsequent processes in FIG. 2.

Next, in the process of resist protective film deposition, a resist protective film 15 is formed on the workpiece 10 having been subjected to the process of resist processing by, for example, sputtering, CVD (Chemical Vapor Deposition) etc. by the process chamber P2 (FIG. 1C). Accordingly, the process chamber P2 is constituted so that it can perform a film-forming treatment such as sputtering and CVD.

In the present embodiment, in performing the process of resist protective film deposition, the consistency of the material of the resist 14 with the material of the resist protective film 15, and the film-forming condition are selected so that the film-forming rate to the resist pattern head part PH becomes higher than that to the resist pattern bottom part PB. From this standpoint, the film is preferably formed by sputtering without applying bias power to the substrate. For example, when a carbonaceous resist is adopted as the resist 14, for example, a carbon film containing carbon as a main ingredient (including a carbon-based film such as diamond-like carbon) may be used as the resist protective film 15 to be formed thereon. As described above, the use of the above-described carbon film as the resist protective film 15 causes the carbon film to grow and accumulate on a resist pattern sidewall PS, too, so as to enwind the resist pattern, and, as the result, causes the height and Duty cycle of the etching mask to increase by the amount of the resist protective film 15 than the sole resist mask (resist 14 shown in FIG. 1B).

As to the material of the resist protective film 15, a material, which can give a selection ratio relative to the recording layer 13 in the process of recording layer processing to be described later, is used. In the present embodiment, since ion beam etching is performed in the process of recording layer processing, a material having an etching rate lower than that of the recording layer 13 is used. That is, as the material of the resist protective film 15, there may be used a material having an etching rate by the etching used in the process of recording layer processing lower than that of the recording layer 13 to be processed in the process. The above-described carbon film is preferable because it satisfies the condition of the selection ratio and has a higher resistance relative to the ion beam than the resist. The carbon film as the resist protective film 15 is produced by a sputtering method using a carbon-containing target, a plasma CVD method using a carbon hydride gas, etc. In any case, it is possible to lead to a state where the deposition amount on the pattern head part is larger by the combination with the carbonaceous resist as the resist 14, and it is preferable to form the film in a state where no bias voltage is applied to the substrate, because the above-described state becomes remarkable.

Next, in the process of resist protective film processing, etching processing is performed on the workpiece 10 having been subjected to the process of resist protective film deposition by etching etc. by the process chamber P3 to thereby remove the resist protective film accumulated at the pattern bottom part (FIG. 1D). Accordingly, the process chamber P3 is constituted so that, for example, it can perform the reactive ion etching (RIE). In the present embodiment, since the formation amount of the resist protective film 15 at the resist pattern head part PH is larger than that at the resist pattern bottom part PB, the height and the width of the carbon protective film 15 after having removed the carbon protective film 15 at the resist pattern bottom part PB are still larger than those of the resist 14 after the process of resist processing (resist 14 in FIG. 1B).

Next, in the process of recording layer processing, the recording layer 13 is etched by using the resist 14 and resist protective film 15 as a mask M by the process chamber P4 to process the recording layer 13 into the same shape as the resist pattern (FIG. 1E). Accordingly, the process chamber P4 is constituted so that it can perform, for example, the reactive ion etching (RIE). No particular limitation is imposed on the etching method if the method can give the selection ratio relative to the mask M, and for example, the ion beam etching can be used. For example, when the above-described carbon film is used as the resist protective film 15, a carbon-based film having a high resistance against the ion beam etching in addition to giving a volume increase in the mask M, is used as the mask. Accordingly, the shrinkage and recession of the mask in the process of recording layer processing are small to thereby improve the Duty cycle and the shape such as the degree of verticality of the sidewall after the recording layer processing, as compared with the case where the resist alone is used.

After that, in the process of mask removal, the mask M is removed by the process chamber P5 (FIG. 1F). Accordingly, the process chamber P5 is constituted so that it can perform, for example, the reactive ion etching (RIE). When the carbon film is adopted as the resist protective film 15, it can be removed along with the resist 14 by the dry etching using the same oxygen gas plasma.

Heretofore, the first embodiment has been explained, but the application of the present invention is not limited to the above embodiment. For example, in the process of resist protective film deposition, if the deposition amount onto the pattern bottom part PB of the resist protective film 15 is extremely smaller than that onto the pattern head part PH, the process of recording layer processing may be performed while omitting the process of resist protective film processing.

Moreover, a recording layer-protecting layer for protecting the recording layer 13, for example, a silicon film having a thickness of about 3 nm may be inserted between the recording layer 13 and the resist 14.

Next, an example of the present invention will be explained.

First, through the use of the manufacturing apparatus shown in FIG. 2, in the process chamber P1, a mixed gas of oxygen and argon gases was caused to discharge by an ICP (Inductively Coupled Plasma) unit, pulse DC bias was applied to the substrate, and, under conditions shown below, the reactive etching was performed on the workpiece 10 as shown in FIG. 1A. This removes the resist 14 left at the bottom part of the resist pattern.

### Processing Condition of Resist:

oxygen gas flow rate: 3 sccm,

Ar gas flow rate: 30 sccm,

pressure: 1 Pa,

discharge power: 200 W,

substrate bias: −30 V, and

etching time: 10 seconds

Next, in the process chamber P2, as shown in FIG. 1C, a carbon film as the resist protective film 15 was formed on the processed resist 14 by magnetron sputtering.

### Film-Forming Condition:

Ar gas flow rate: 100 sccm,

pressure: 0.7 Pa,

discharge power: 1000 W,

substrate bias: not applied, and

film-forming time: 25 seconds

Next, in the process chamber P3, as shown in FIG. 1D, the carbon film accumulated at the resist pattern bottom part of the resist 14 was removed. Specifically, the mixed gas of oxygen and argon gases was discharged by an ICP unit, and pulse DC bias was applied to the substrate to perform reactive etching on the workpiece 10 as shown in FIG. 1C.

### Etching Condition:

oxygen gas flow rate: 3 sccm,

Ar gas flow rate: 30 sccm,

pressure: 1 pa,

discharge power: 200 w,

substrate bias: −30 V, and

etching time: 10 seconds

Next, in the process chamber P4, through the use of the pattern of the processed mask M, an ion beam etching (IBE) unit was used to discharge Ar gas, and the Ar ions were accelerated by a grid to perform ion beam etching on the recording layer 13.

### Ion Beam Condition:

Ar gas flow rate: 5 sccm,

pressure: 0.04 Pa,

discharge power: 200 W,

ion acceleration voltage: 1000 V,

ion beam power: 150 W, and

etching time: 20 seconds

Next, in the process chamber P5, the mask M left on the workpiece 10, having been subjected to recording layer processing, was removed. Specifically, a mixed gas of oxygen and argon gases was discharged by the ICP unit to remove the mask M by reactive etching.

### Etching Condition:

oxygen gas flow rate: 3 sccm,

Ar gas flow rate: 30 sccm,

pressure: 1 Pa,

discharge power: 200 W,

substrate bias: −50 V, and

etching time: 30 seconds

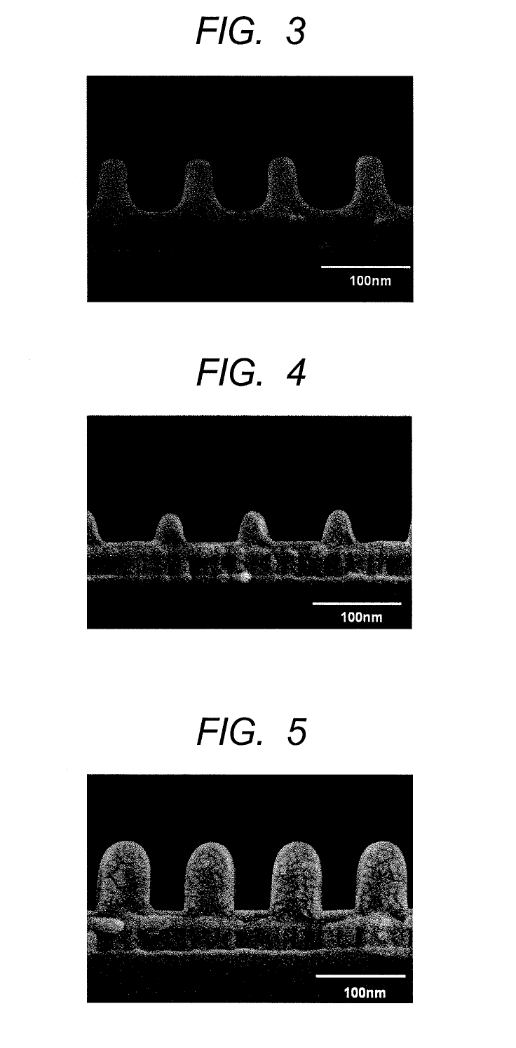

FIG. 3 is a SEM photograph of the workpiece before the process of resist processing, FIG. 4 is a SEM photograph of the workpiece after the process of resist processing, and FIG. 5 is a SEM photograph of the workpiece after the deposition of the resist protective film. It can be confirmed that the resist at the pattern bottom part is removed by the process of resist processing, and that the height and width of the resist 14 are shrunk considerably (FIG. 4). After depositing a carbon film as the resist protective film 15 on the same by sputtering, the mask increased to 48 nm in the height and to 18 nm in the width, while on the other hand, the thickness of the film deposited at the pattern bottom was only 7 nm, which shows that the resist protective film 15 is deposited by surrounding the resist 14. It was confirmed that the process of resist protective film deposition was able to largely improve the height and Duty cycle of the mask (FIG. 5).

What is claimed is:

1. A manufacturing method of magnetic recording medium that processes a recording layer by etching, comprising the steps of:
depositing a material having an etching rate by the etching lower than that of the recording layer, on a resist pattern formed on a workpiece containing the recording layer, and
processing the recording layer into the same shape as the resist pattern by the etching using the resist pattern and the material as a mask.

2. The manufacturing method of a magnetic recording medium according to claim 1, further comprising the step of processing the resist pattern and the material to shape these into the mask by removing the material present at the resist pattern bottom part between the deposition step and the recording layer processing step.

3. The manufacturing method of a magnetic recording medium according to claim 1, wherein the deposition step deposits the material under such a condition that the film-forming rate of the material on the resist pattern head part is higher than the film-forming rate of the material on the resist pattern bottom part.

4. The manufacturing method of a magnetic recording medium according to claim 1, wherein the material contains carbon as a main ingredient.
